(19) United States
(12) Patent Application Publication
(10) Pub. No.: US 2025/0106578 A1
(43) Pub. Date: Mar. 27, 2025

(54) CONVERTING STEREO AUDIO CONTENT TO MONO AUDIO CONTENT BASED ON EARPHONE USAGE

(71) Applicant: Motorola Mobility LLC, Chicago, IL (US)

(72) Inventors: Amit Kumar Agrawal, Bangalore (IN); Himanshu Chug, Bangalore (IN); Aman Jain, Panchkula (IN)

(73) Assignee: Motorola Mobility LLC, Chicago, IL (US)

(21) Appl. No.: 18/373,431

(22) Filed: Sep. 27, 2023

(51) Int. Cl. H04S 7/00; G06F 3/16; H04R 1/10

(52) U.S. Cl. CPC H04S 7/30; G06F 3/165; H04R 1/10

(57) ABSTRACT

In aspects of converting stereo audio content to mono audio content based on earphone usage, a mobile device identifies a first earphone of a pair of earphones connected to the electronic device, the pair of earphones including the first earphone and a second earphone, converts stereo audio content to mono audio content in response to a detection that the first earphone is used by a first user and that the second earphone is not used by the first user, and transmits the mono audio content to the first earphone.

### BACKGROUND

Wireless earphones (e.g., in-ear wireless headphones, wireless earbuds, true wireless stereo (TWS) earbuds) are becoming increasingly popular. Wireless earphones include a variety of features such as spatial audio, customizable equalizer, and active noise canceling. Wireless earphones are typically used in conjunction with an audio source device (e.g., mobile device, a smartphone, or some other media device). The audio source device is configured to transmit stereo audio content to a pair of wireless earphones. Stereo audio content includes a right channel and a left channel. When the audio source device transmits stereo audio content to a pair of wireless earphones, the right channel goes to a right earphone and the left channel goes to a left earphone. In some cases, the audio content on the left channel varies from the audio content on the right channel. Thus, some of the stereo audio content can be lost by one or more users when a first user uses a first earphone and a second user uses a second earphone.

### BRIEF DESCRIPTION OF THE DRAWINGS

Implementations of the techniques for converting stereo audio content to mono audio content based on earphone usage are described with reference to the following Figures. The same numbers may be used throughout to reference like features and components shown in the Figures.

FIG. 1 illustrates an example system for converting stereo audio content to mono audio content based on earphone usage in accordance with one or more implementations as described herein.

FIG. 2 further illustrates an example system for converting stereo audio content to mono audio content based on earphone usage in accordance with one or more implementations as described herein.

FIG. 3 illustrates an example flow diagram for converting stereo audio content to mono audio content based on earphone usage in accordance with one or more implementations as described herein.

FIGS. 4 and 5 illustrate example methods for converting stereo audio content to mono audio content based on earphone usage in accordance with one or more implementations of the techniques described herein.

FIG. 6 illustrates various components of an example device that may be used to implement the techniques for converting stereo audio content to mono audio content based on earphone usage as described herein.

### DETAILED DESCRIPTION

When stereo audio content with a right channel and a left channel is transmitted to a pair of earphones, the first earphone receives the right channel for the right ear and the second earphone receives the left channel for the left ear. Thus, if a pair of wireless earphones are shared by two persons (e.g., to listen to music, watch a movie, etc.), then a first person can listen to the right channel on the first earphone while the second person can listen to the left channel on the second earphone. However, when the audio of the right channel differs from the audio of the left channel, then the first person and/or the second person can lose parts of the stereo audio content based on each user only having a single earphone. For example, a couple shares a pair of earbuds while roaming in a park, sharing music to enjoy the same music together, while keeping one ear available to hear each other and be aware of sounds around them in their environment. They listen to the music, but feel that there is something wrong with the experience. The music does not sound the same. Some of the content is diminished while other parts are amplified. For example, one spouse can hear the vocals clearly, but the piano is diminished. The other spouse can hear the piano clearly, but the vocals are diminished. The couple stop listening to the music because the audio quality is diminished when each of them is using a single earphone from the pair of earphones.

The audio processing functionality described herein remedies such situations based on the audio controller monitoring usage of the earphones and automatically modifying the stereo audio content when, based on the monitoring, the audio controller detects the earphones being shared, detects the earphones being used by one user, and/or detects the first earphone being used by a user and the second earphone not being used.

In aspects of the described techniques, the audio controller implements the audio processing functionality described herein to enable sharing of the stereo audio content when earphones are being shared by two users. In one or more examples, the audio processing functionality is performed via at least one electronic device that implements an instantiation of an audio controller.

In implementations, the audio controller can determine that a pair of earphones are linked (e.g., communicatively connected) to an audio source device (e.g., electronic device) that is configured to provide audio content to the earphones (e.g., mobile device, smartphone, tablet, television, radio, etc.). The earphones provide features that are based on one or more sensors incorporated into the earphones. The one or more sensors allow for one or more of fast pairing, in-ear detection, head movement detection, and gesture control to control one or more aspects of the earphones (e.g., adjust volume, play content, pause content, skip ahead, rewind, etc.). Additionally or alternatively, the one or more sensors of the earphones are configured to detect whether a user is using one earphone or both earphones, or whether a first user is using a first earphone and a second user is using a second earphone. The audio controller receives one or more messages from at least one sensor of the earphones configured to provide sensor data.

When one or more sensors indicate that both earphones are connected to the audio source device, the one or more sensors of the earphones are configured to detect whether at least one earphone is being used by a single user or whether the earphones are being shared by two users. In one or more examples, the earphones include a proximity sensor (e.g., capacitive proximity sensor) that is configured to detect when an earphone is or isn't being worn by a user. For example, the proximity sensor is configured to detect when an earphone is picked up by a user, is being held by a user, is being placed in a user's ear, is currently placed in a user's ear, and/or when there is an absence of human contact. In one or more examples, the earphones include a motion sensor (e.g., inertial measurement unit (IMU)) configured to detect relative movement of an earphone.

When the audio controller detects, based on sensor data, that a single user is wearing both earphones, the audio controller provides stereo audio content to the earphones, routing a first channel of the stereo audio content to a first earphone and routing a second channel of the stereo audio content to a second earphone.

When the audio controller detects, based on sensor data, that a first user is wearing the first earphone and that a second person is wearing the second earphone, the audio controller converts the stereo audio content to mono audio content. For example, the audio controller merges content of the right channel with content of the left channel into a single mono channel. Thus, when the right channel includes content and the left channel does not include content, and/or the left channel includes content and the right channel does not include content, the merging of the channels ensures that all of the content is included in the mono audio content. The audio controller then routes the mono audio content to the first earphone and to the second earphone. Thus, each user receives all of the content from the right channel and the left channel of the stereo audio content without any loss of audio data. When the audio controller detects that a first channel of stereo audio content includes content and that the second channel lacks the content of the first channel, the audio controller adds the content of the first channel to the second channel and transmits the combined channels to one or more headphones.

It is noted that audio content can include more than two channels. For example, quadraphonic or surround sound can include three or more channels (e.g., left channel, right channel, center channel, rear left channel, rear right channel, bass channel). When the audio controller determines that a single user is using the earphones and that the audio content includes three or more channels, the audio controller converts the three or more channels into two channels (e.g., left channel and right channel), transmitting the channels respectively to the pair of earphones. Additionally or alternatively, when the audio controller detects that a pair of earphones are being shared and the audio content includes three or more channels, the audio controller converts the three or more channels into stereo audio content (e.g., two channels) and then converts the stereo audio content into mono audio content and transmits the mono audio content to each earphone. Additionally or alternatively, the audio controller converts the three or more channels directly into mono audio content and transmits the mono audio content to each earphone.

The audio processing functionality of the audio controller described herein provides multiple advantages. For example, detecting when earphones are shared and, in response to the detection, converting the stereo audio content to mono audio content and routing the mono audio content to each earphone enables each user sharing the earphones to receive the complete audio content without any loss of audio data. The detection of earphone sharing or single earphone usage and the resulting conversion of stereo audio content to mono audio content are performed automatically by the audio controller without user input. Thus, the audio processing functionality described herein improves user experience by converting the stereo audio content to mono audio content without user input. For example, the audio controller automatically detects earphone sharing or single earphone usage and automatically converts the stereo audio content to mono audio content without the user having to adjust any settings of the earphones or adjust any settings of the device that provides the audio content to the earphones (e.g., smartphone, tablet, television, radio, etc.).

Similarly, the audio processing functionality described herein improves user experience by automatically converting mono audio content to stereo audio content without user input. For example, the audio controller automatically detects when a user switches from sharing earphones to wearing both earphones and automatically converts the mono audio content to stereo audio content without the user having to adjust any settings of the earphones or adjust any settings of the device that provides the audio content to the earphones. Also, the audio controller automatically detects when a user switches from using a single earphone to wearing both earphones and automatically converts the mono audio content to stereo audio content without the user having to adjust any settings of the earphones or adjust any settings of the device that provides the audio content to the earphones.

While features and concepts of the described techniques for converting stereo audio content to mono audio content based on earphone usage are implemented in any number of different mobile devices, systems, environments, and/or configurations, implementations of the techniques for converting stereo audio content to mono audio content based on earphone usage are described in the context of the following example devices, systems, and methods.

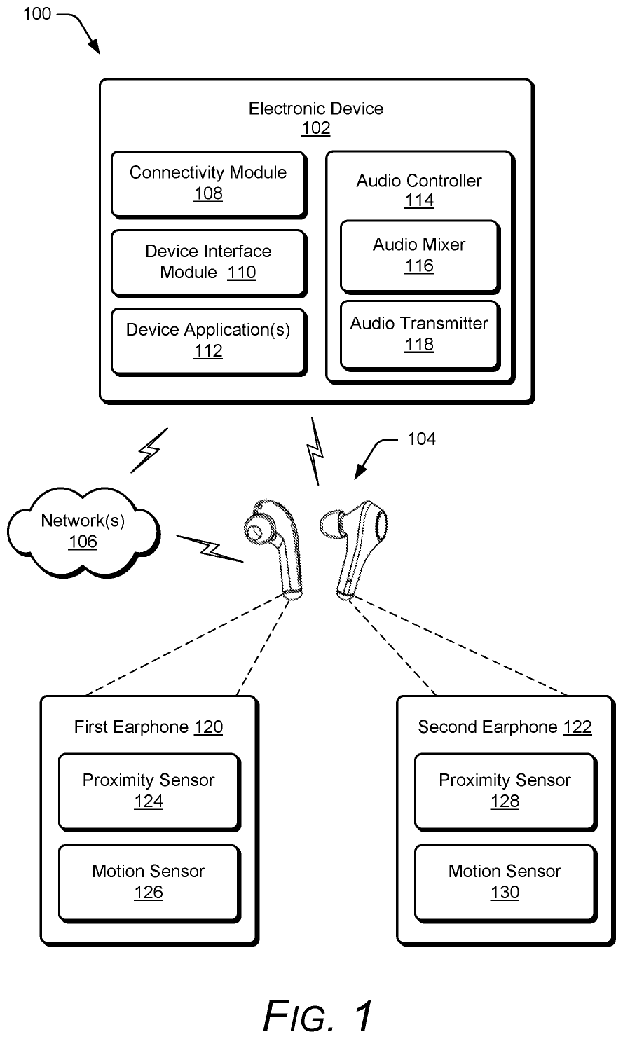

FIG. 1 illustrates an example system 100 for converting stereo audio content to mono audio content based on earphone usage, as described herein. The system 100 includes one or more electronic devices, such as an electronic device 102. Examples of electronic devices include at least one of any type of a wireless device, mobile phone, flip phone, client device, game controller, wearable computing device, camera device, Internet of Things (IoT) device, display device, tablet computer, laptop computer, desktop computer, communication device, entertainment device, gaming device, media playback device, a television, a radio, an audio video receiver, a remote control with audio output, a media streaming device, any other type of computing and/or electronic device, and/or a system of any combination of such devices.

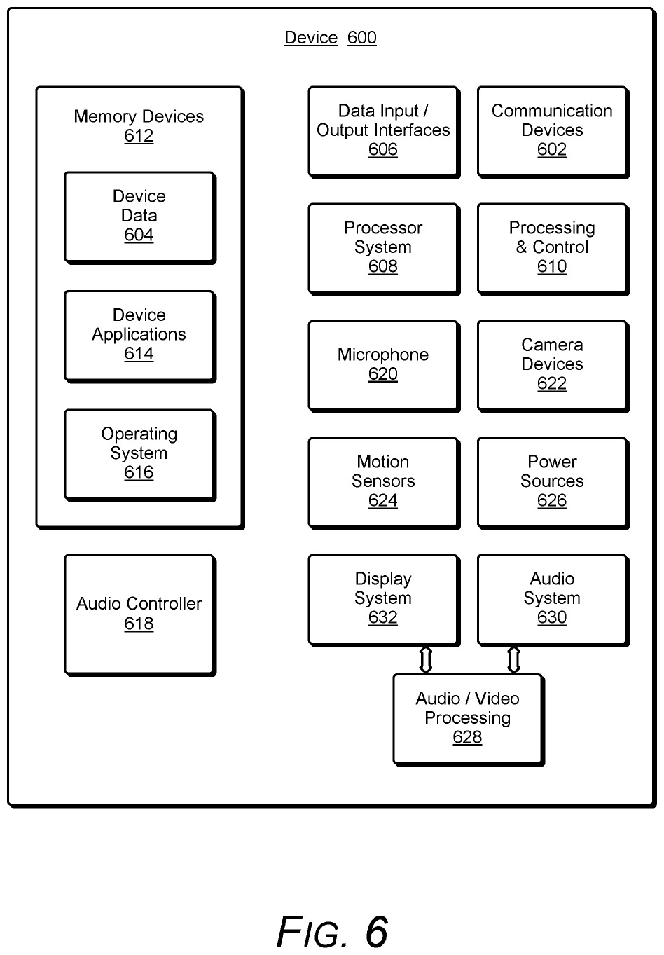

The electronic device 102 is implemented with various components, such as a processor system and memory, as well as any number and combination of different components as further described with reference to the example device shown in FIG. 6. In implementations, the electronic device 102 includes various radios for wireless communication with other devices. In one or more examples, the electronic device 102 includes at least one of a BLUETOOTH® (BT) or BLUETOOTH® Low Energy (BLE) transceiver, a near field communication (NFC) transceiver, or the like. In some cases, the electronic device 102 includes at least one of a WI-FI® radio, a cellular radio, a global positioning satellite (GPS) radio, or any available type of device communication interface.

The system 100 includes earphones 104, such as any type of short-range wireless communication audio output devices, in-ear wireless headphones, wireless earbuds, true wireless stereo (TWS) earbuds, and the like. The earphones 104 are implemented with various components, such as a processor system and memory, as well as any number and combination of the different components as further described with reference to the example device shown in FIG. 6. In implementations, the electronic device 102 is communicatively linked, by a wired or wireless connection, to the earphones 104. For example, the electronic device 102 and the earphones 104 are communicatively linked via a communication network 106 and/or via direct inter-device connectivity, e.g., via direct wireless and/or wired connectivity between the electronic device 102 and the earphones 104 (e.g., via short-range wireless communication, via BLUETOOTH, etc.).

In some implementations, the devices, applications, modules, servers, and/or services described herein communicate via the communication network 106, such as for data communication between the electronic device 102 and the earphones 104. The communication network 106 includes a wired and/or a wireless network. The communication network 106 is implemented using any type of network topology and/or communication protocol, and is represented or otherwise implemented as a combination of two or more networks, to include short-range wireless networks, IP-based networks, cellular networks, and/or the Internet. The communication network 106 includes mobile operator networks that are managed by a mobile network operator and/or other network operators, such as a communication service provider, mobile phone provider, and/or Internet service provider.

The electronic device 102 includes various functionalities that enable the device to implement different aspects of converting stereo audio content to mono audio content based on earphone usage, as described herein. In the illustrated example, the electronic device 102 includes a connectivity module 108, a device interface module 110, device applications 112, and an audio controller 114. The connectivity module 108 represents functionality (e.g., logic, software, and/or hardware) enabling the electronic device 102 to interconnect with other devices and/or networks, such as the earphones 104 and the communication network 106. For example, the connectivity module 108 enables wireless and/or wired connectivity of the electronic device 102. The device interface module 110 represents functionality enabling the electronic device 102 to interface with other devices. As further detailed below, the device interface module 110 enables the electronic device 102 to establish wireless and/or wired data communication with other devices, such as the earphones 104.

The earphones 104 include various functionality that enables the computing device to implement different aspects of converting stereo audio content to mono audio content based on earphone usage, as described herein. In the illustrated example, the earphones 104 includes a first earphone 120 and a second earphone 122. In one or more examples, the first earphone 120 includes a proximity sensor 124 and/or a motion sensor 126. Additionally or alternatively, the second earphone 122 includes a proximity sensor 128 and/or a motion sensor 130.

The proximity sensor 124 and/or the proximity sensor 128 represents functionality (e.g., logic, software, and/or hardware) enabling a respective earphone to detect a proximity to human contact such as a fingertip touching an earphone, an earphone placed in an ear, a gesture of a hand relatively near an earphone. Sensor data from the proximity sensor 124 and/or the proximity sensor 128 enables the audio controller 114 to determine whether the first earphone 120 and/or the second earphone 122 are being used by a user (e.g., held by a hand, being placed in an ear, currently in an ear, gesture input, tapped on, etc.).

The motion sensor 126 and/or the motion sensor 130 represents functionality (e.g., logic, software, and/or hardware) enabling a respective earphone to detect movement and motion relative to an earphone held in a hand and/or an earphone placed in an ear. Sensor data from the motion sensor 126 and/or the motion sensor 130 enables the audio controller 114 to determine when the first earphone 120 and the second earphone 122 are worn by the same user or when the first earphone 120 is worn by a first user and the second earphone 122 is worn by a second user.

The electronic device 102 can include and implement device applications 112, such as any type of messaging application, email application, video communication application, cellular communication application, music/audio application, radio application, podcast application, audio book application, movie application, video sharing application, gaming application, media application, social platform application, and/or any other of the many possible types of device applications. Many of the device applications 112 have an associated application user interface that is generated and displayed for user interaction and viewing, such as on a display screen of the electronic device 102. Generally, an application user interface, or any other type of video, image, graphic, and the like is digital image content that is displayable on the display screen of the electronic device 102.

The audio controller 114 represents functionality (e.g., logic, software, and/or hardware) enabling implementation of described techniques for converting stereo audio content to mono audio content based on earphone usage. In the example system 100 for converting stereo audio content to mono audio content based on earphone usage, the electronic device 102 and the earphones 104 incorporate smart audio processing functionality. At least one of the electronic device 102 or the earphones 104 implements an instantiation of and/or one or more aspects of the logic, hardware, and/or software of the audio controller 114 (e.g., as a device application 112). The audio controller 114 can be implemented as computer instructions stored on computer-readable storage media and can be executed by a processor system of the electronic device 102 and/or of the earphones 104. Alternatively or in addition, the audio controller 114 can be implemented at least partially in hardware of a device.

In one or more implementations, the audio controller 114 includes independent processing, memory, and/or logic components functioning as a computing and/or electronic device integrated with the electronic device 102 and/or with the earphones 104. Alternatively or in addition, the audio controller 114 can be implemented in software, in hardware, or as a combination of software and hardware components. In one or more examples, the audio controller 114 is implemented as a software application or module, such as executable software instructions (e.g., computer-executable instructions) that are executable with a processor system of the electronic device 102 and/or the earphones 104 to implement the techniques and features described herein. As a software application or module, the audio controller 114 is stored on computer-readable storage memory (e.g., memory of a device), or in any other suitable memory device or electronic data storage implemented with the module. Alternatively or in addition, the audio controller 114 is implemented in firmware and/or at least partially in computer hardware. For example, at least part of the audio controller 114 is executable by a computer processor, and/or at least part of the audio controller 114 is implemented in logic circuitry.

In the illustrated example, the audio controller 114 includes an audio mixer 116 and an audio transmitter 118. As shown, the first earphone 120 includes a proximity sensor 124 and a motion sensor 126. Similarly, the second earphone 122 includes a proximity sensor 128 and a motion sensor 130. In implementations, the audio controller 114 identifies a first earphone 120 of the earphones 104 connected to the electronic device. The audio mixer 116 converts stereo audio content to mono audio content in response to the audio controller 114 detecting that the first earphone 120 is used by a first user and that the second earphone 122 is not used by the first user. The audio transmitter 118 then transmits the mono audio content to the first earphone 120. In one or more examples, the conversion of the stereo audio content to the mono audio content is based on the audio controller 114 detecting content of a first channel of the stereo audio content that is absent on a second channel of the stereo audio content and the audio mixer 116 adding the content of the first channel to the second channel.

In one or more variations, the audio controller 114 receives (e.g., after the mono audio content is transmitted to the first earphone 120) a connection request from the second earphone 122 to connect the second earphone 122 to the electronic device 102. In implementations, the audio controller 114 detects that the second earphone 122 is used by a second user and the first earphone 120 is used by the first user. Accordingly, the audio transmitter 118 transmits the mono audio content to the first earphone 120 and to the second earphone 122.

In implementations, the audio controller 114 detects that the first earphone 120 and the second earphone 122 are worn by the first user. Accordingly, the audio controller 114 stops the conversion of the stereo audio content to the mono audio content and transmits a first channel of the stereo audio content to the first earphone 120 and a second channel of the stereo audio content to the second earphone 122. Additionally or alternatively, after the second user uses the second earphone 122, when the audio controller 114 detects that the first earphone 120 and the second earphone 122 are used by the first user (e.g., after the second user gives the second earphone 122 back to the first user), then the audio controller 114 stops the conversion of the stereo audio content to the mono audio content and transmits the first channel of the stereo audio content to the first earphone 120 and the second channel of the stereo audio content to the second earphone 122.

In implementations, the audio controller 114 detects destructive interference based on a first channel of the stereo audio content being combined with a second channel of the stereo audio content. Before conversion of the stereo audio content to the mono audio content, the audio controller 114 performs signal processing on at least one of the first channel or the second channel to remove the destructive interference.

In implementations, the audio controller 114 detecting that the second earphone is used by the second user and the first earphone is used by the first user is based on the audio controller 114 analyzing a signal from the motion sensor 126 of the first earphone 120 and a signal from the motion sensor 130 of the second earphone 122 and determining, based on the analysis, that the first earphone 120 and the second earphone 122 are worn by different users. Additionally or alternatively, the audio controller 114 detecting that the first earphone 120 is used by the first user is based on the audio controller 114 receiving a proximity indication from the proximity sensor 124 of the first earphone 120 and determining that the first earphone 120 is used by the first user based on the proximity indication.

In implementations, the proximity sensor 124 and/or the proximity sensor 128 include a capacitance sensor. The proximity sensor 124 and/or the proximity sensor 128 are configured to sense proximity between a respective earphone and a user (e.g., proximity to a user's finger or ear). For example, the proximity sensor 124 and/or the proximity sensor 128 are configured to provide in-ear detection. Additionally or alternatively, the proximity sensor 124 and/or the proximity sensor 128 are configured to sense a touch and/or a tap on a respective earphone. Additionally or alternatively, the proximity sensor 124 and/or the proximity sensor 128 are configured to sense gestures to enable a user to control one or more aspects of the earphones 104 (e.g., raise volume, lower volume, play content, pause content, skip ahead, rewind, etc.).

In implementations, the motion sensor 126 and/or the motion sensor 130 include an accelerometer, a gyroscope sensor, and/or a magnetometer. The motion sensor 126 and/or the motion sensor 130 are configured to detect and track earphone position, earphone orientation, earphone velocity. The motion sensor 126 and/or the motion sensor 130 can track head movements relative to a respective earphone worn in an ear of a user. For example, the motion sensor 126 and/or the motion sensor 130 detect matching motion and synchronization of starting and stopping of movement when the earphones are used by one person. Additionally or alternatively, the motion sensor 126 indicate a relative movement of the first earphone 120 and/or the motion sensor 130 indicates a relative movement of the second earphone 122.

In implementations, the audio controller 114 receives one or more messages from the motion sensor 126 and/or the motion sensor 130 indicating the relative movement of the first earphone 120 and/or the second earphone 122. When the audio controller 114 receives motion sensor data from each earphone, the audio controller 114 determines whether the first earphone 120 and the second earphone 122 are worn by a single user or whether the earphones are worn by different users based on an analysis of the relative movements. For example, the audio controller 114 receives the motion sensor data and determines, based on an analysis of the motion sensor data of each earphone, whether a detected motion of the first earphone 120 is synchronized with a detected motion of the second earphone 122. The audio controller 114 determines that the first earphone 120 and the second earphone 122 are worn by a single user when the analysis indicates that the detected motion of the first earphone 120 is synchronized with the detected motion of the second earphone 122. The audio controller 114 determines that the first earphone 120 and the second earphone 122 are worn by different users when the analysis indicates that the detected motion of the first earphone 120 diverges from (e.g., is not synchronized with) the detected motion of the second earphone 122.

In one or more examples, the audio controller 114 receives earphone data in addition to proximity sensor data and motion sensor data. For example, the audio controller 114 can receive microphone data and determine whether the earphones 104 are worn by the same user or by different users by detecting similar audio levels belonging to the same voice at respective microphones on the first earphone 120 and the second earphone 122. The audio controller 114 can determine when the earphones 104 are worn by separate users by detecting different audio levels of a voice of a same user at each of the earphones 104. For example, the audio controller 114 can detect stronger voice levels of one user at the first earphone 120 than at the second earphone 122, such as when the user is speaking during content playback. The audio controller 114 can accordingly determine the earphones 104 are being shared, identify the owner based on speech recognition, voice identification, voice tone, contextual phrases, etc., and determine when the first earphone 120 and the second earphone 122 are worn by a single user or shared by two users.

There can be other ways of determining the usage or sharing state of the earphones 104. One way can include turning on a camera on the electronic device 102 when different users are wearing each of the earphones 104. The camera can then determine which earphone the owner is wearing based on facial recognition, based on which user is holding the electronic device 102, based on identification of an earphone, and/or based on other visual information. The camera can also be used by turning it on every time the electronic device 102 engages with an earphone and when sensors on the electronic device 102 are triggered, such as by using volume knobs, touch screens, app engagement to change music, and other triggers on the electronic device 102. The camera can also confirm the owner's voice by capturing an image or video of the user holding and/or controlling the electronic device 102 and by matching audio capture with lip movement. The camera can also be used to determine which user is in front of the electronic device 102 and wearing a particular earphone. If more than one earphone is linked to the electronic device 102, the camera can be launched and the audio controller 114 can assess whether a user is wearing one earphone or both based on image analysis.

There can be various modes of determining whether the earphones 104 are shared. One mode can be a manual mode where a user can manually define and confirm the sharing status when one earphone is shared. For example, the user can double tap an earpiece on the first earphone 120 to confirm which earphone is in the ear of the owner of the electronic device 102 and the other earphone is shared. Another mode can be a voice mode where the user can authorize an earphone via voice commands when one of the earphones 104 is shared. The authorization message can be implicit, such as “I give the left one to you” or “I keep the right one.” The audio controller 114 and or one or both of the earphones 104 can listen and recognize the user's voice to establish sharing mode and determine that one earphone is shared. Yet another mode can be a contextual mode where earphone sharing can be determined by various contexts described in some or all of the described techniques. Also, another mode can be a fingerprint mode where the earphones 104 can include fingerprint sensors. Thus, when the non-owner uses an earphone and touches the fingerprint sensor, the earphone and/or the audio controller 114 can determine that a particular earphone is not the owner's ear and it is thus the earphones 104 are being shared. Another possible implementation can be where a fingerprint sensor can verify the owner's fingerprint and determine an earphone is being worn by the owner.

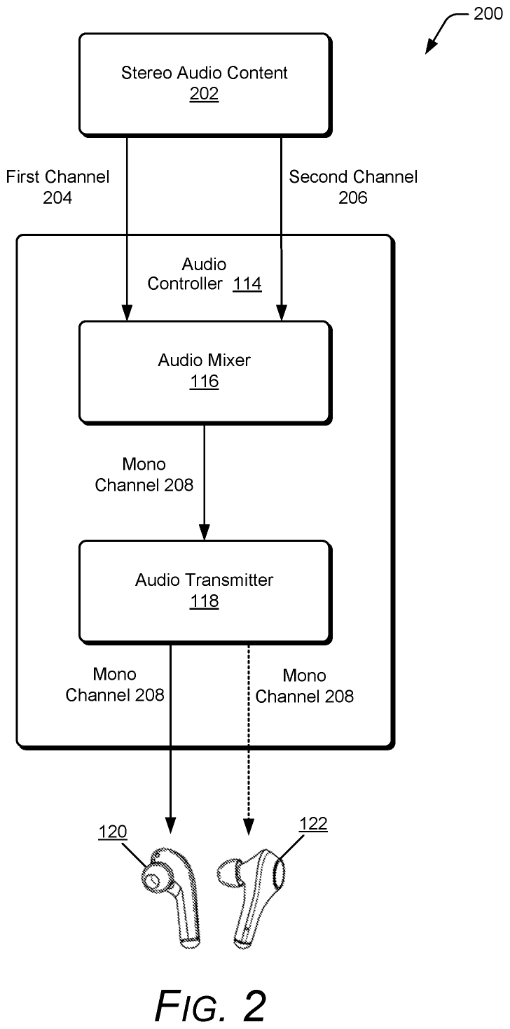

FIG. 2 further illustrates an example system 200 for converting stereo audio content to mono audio content based on earphone usage, as described herein. As shown, the system 200 includes stereo audio content 202, the audio controller 114, the first earphone 120, and the second earphone 122.

In one or more examples, the stereo audio content 202 is stored on a storage device of the electronic device 102, is transmitted to the electronic device 102, and/or is provided by a live source (e.g., a radio signal, a microphone and/or musical instrument connected to the electronic device 102, etc.). As shown, the stereo audio content 202 includes a first channel 204 and a second channel 206. For example, the stereo audio content 202 includes a right channel and a left channel. As shown, the first channel 204 and the second channel 206 are provided to the audio mixer 116 of the audio controller 114. The audio mixer 116 include any combination of hardware, software, and/or logic to process incoming audio signals. In some cases, the audio mixer 116 includes an equalizer to equalize an audio level of the first channel 204 and/or an audio level the second channel 206. In some cases, the audio mixer 116 equalizes the first channel 204 and the second channel 206 so that the respective audio levels (e.g., volume, signal amplitude, etc.) match.

In implementations, the audio mixer 116 is configured to downmix a left channel and a right channel into a single mono stream when the audio controller 114 determines that a user is wearing the first earphone 120 and the second earphone 122 is not being used, or when the audio controller 114 determines that the first earphone 120 is being worn by a first user and the second earphone 122 is being worn by a second user. For example, the audio mixer 116 downmixes the first channel 204 and the second channel 206 to a mono channel 208.

As shown, the audio transmitter 118 receives the mono channel 208 and transmits the mono channel 208 to the first earphone 120 when a user is wearing the first earphone 120 and the second earphone 122 is not being worn. Additionally or alternatively, the audio transmitter 118 receives the mono channel 208 and transmits the mono channel 208 to the first earphone 120 and the mono channel 208 to the second earphone 122 when a first user is wearing the first earphone 120 and a second user is wearing the second earphone 122.

In implementations, the audio mixer 116 continues downmixing the first channel 204 and the second channel 206 into the mono channel 208 when the audio controller 114 detects that the first user is still wearing the first earphone 120 and the second user is no longer wearing the second earphone 122 (e.g., the second user gives the second earphone 122 back to the first user). For example, after transmitting the mono channel 208 to the first earphone 120 and the second earphone 122 based on the first user wearing the first earphone 120 and the second user wearing the second earphone 122, the audio mixer 116 continues the downmixing based on the first user continuing to wear the first earphone 120 and the second earphone 122 not being used.

In implementations, the audio mixer 116 stops downmixing the first channel 204 and the second channel 206 into the mono channel 208 when the audio controller 114 detects that a single user is wearing the first earphone 120 and the second earphone 122. For example, after transmitting the mono channel 208 to the first earphone 120 and the second earphone 122 based on the first earphone 120 and the second earphone 122 being shared, the audio mixer 116 stops the downmixing when the first user begins wearing the second earphone 122 and the first earphone 120 (e.g., after the second user gives the second earphone 122 back to the first user). Accordingly, in such cases, the audio mixer 116 provides the first channel 204 and the second channel 206 to the audio transmitter 118. The audio transmitter 118 then transmits the first channel 204 to the first earphone 120 and transmits the second channel 206 to the second earphone 122.

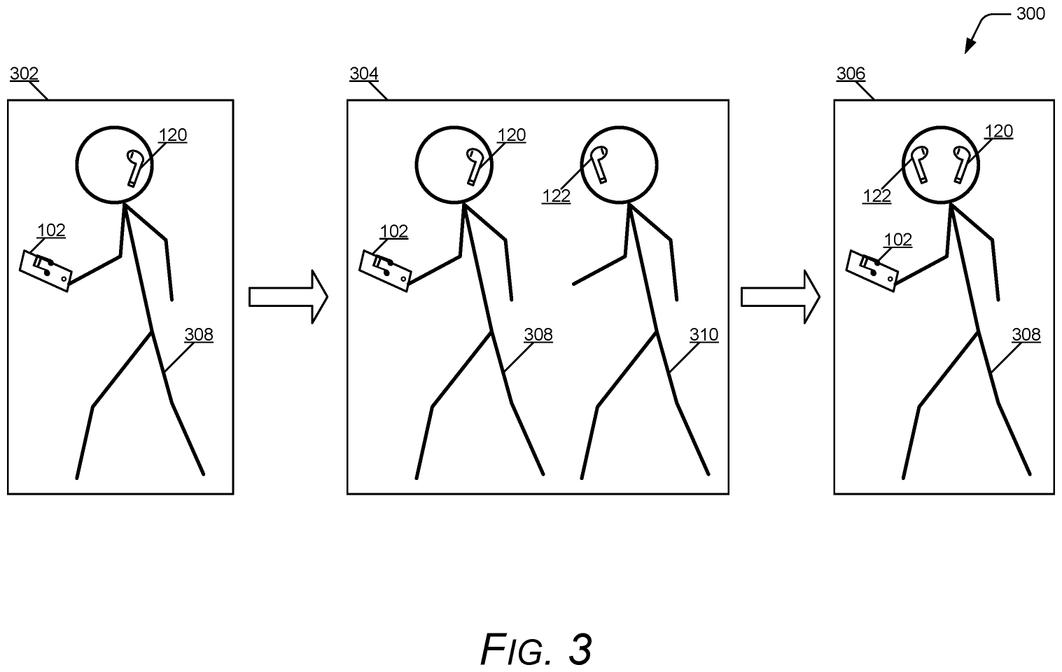

Example flow diagram 300 and methods 400 and 500 are described with reference to respective FIGS. 3, 4, and 5 in accordance with one or more implementations of converting stereo audio content to mono audio content based on earphone usage, as described herein. Generally, any services, components, modules, managers, controllers, methods, and/or operations described herein can be implemented using software, firmware, hardware (e.g., fixed logic circuitry), manual processing, or any combination thereof. Some operations of the example flow diagram and/or methods are described in the general context of executable instructions stored on computer-readable storage memory that is local and/or remote to a computer processing system, and one or more implementations include software applications, programs, functions, and the like. Alternatively or in addition, any of the functionality described herein is performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

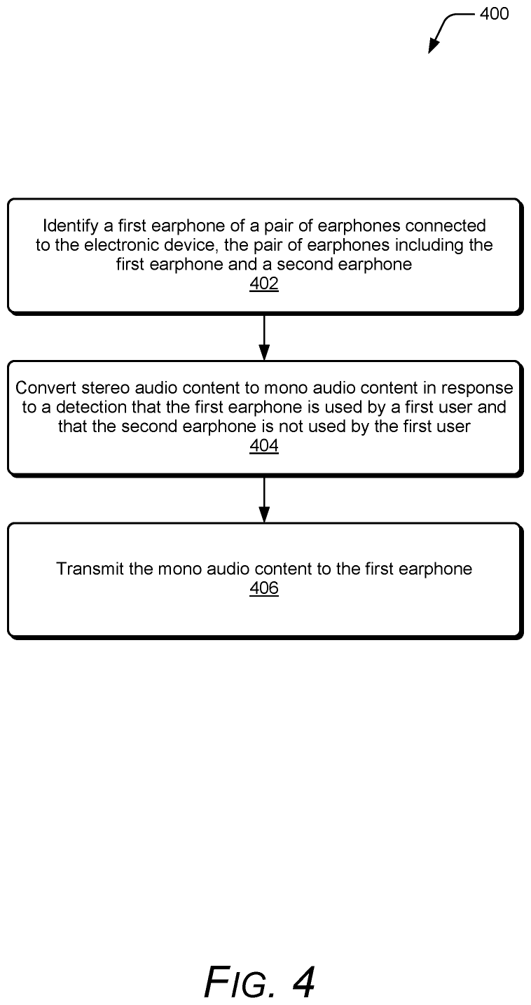

FIG. 3 illustrates an example flow diagram 300 for converting stereo audio content to mono audio content based on earphone usage in accordance with one or more implementations as described herein. As shown, the flow diagram 300 depicts a storyboard flow diagram demonstrating the audio processing functionality described herein. In some configurations, the flow diagram 300 may be implemented by the audio controller 114 illustrated in FIG. 1 or 2. In some configurations, the flow diagram 300 may be implemented in conjunction with the electronic device 102, the earphones 104, components thereof, or any combination thereof. The order in which a flow diagram or method is described is not intended to be construed as a limitation, and any number or combination of flow diagram and/or method operations described herein (e.g., of FIGS. 3, 4, and/or 5) may be performed in any order, number, or combination to perform any variation of a flow diagram and/or method described herein.

As shown, the flow diagram 300 includes a frame 302, a frame 304, and a frame 306. Each of the frames 302, 304, and 306 can occur individually (e.g., independently of one another) and/or in any combination, number, or order. In one or more examples, the frame 302 occurs before the frame 304, and the frame 304 occurs before the frame 306. In one or more variations, the frame 306 occurs before the frame 302 and/or the frame 304. Additionally or alternatively, the frame 304 occurs before the frame 302 and/or the frame 306. The frames 302, 304, and 306 can repeat any number of times. In one or more examples, the frame 306 occurs before the frame 302, the frame 302 is followed by the frame 304, the frame 304 is followed by a second instance of the frame 302, and the second instance of the frame 302 is followed by a second instance of the frame 306.

At frame 302, a first user 308 uses the first earphone 120 to listen to stereo audio content provided by the electronic device 102. In the illustrated example, the first user 308 uses the first earphone 120 while the second earphone 122 is unused. Based on the audio controller 114 detecting that the first user 308 uses the first earphone 120 while the second earphone 122 is unused, the audio controller 114 converts the stereo audio content of the electronic device 102 to mono audio content and provides the mono audio content to the first earphone 120.

At frame 304, the first user 308 uses the first earphone 120 to listen to stereo audio content provided by the electronic device 102 while the second earphone 122 is used by a second user 310. Based on the audio controller 114 detecting that the first user 308 uses the first earphone 120 and the second user 310 uses the second earphone 122, the audio controller 114 converts the stereo audio content of the electronic device 102 to mono audio content and provides the mono audio content to the first earphone 120 and the second earphone 122.

At frame 306, the first user 308 uses the first earphone 120 and the second earphone 122 to listen to stereo audio content provided by the electronic device 102. Based on the audio controller 114 detecting that the first user 308 uses the first earphone 120 and the second earphone 122, the audio controller 114 provides a first channel of the stereo audio content to the first earphone 120 and provides a second channel of the stereo audio content to the second earphone 122. For example, the audio controller 114 stops converting the stereo audio content of the electronic device 102 to mono audio content and provides the stereo audio content to the first earphone 120 and the second earphone 122.

FIG. 4 illustrates example method(s) 400 for converting stereo audio content to mono audio content based on earphone usage. The order in which a flow diagram or method is described is not intended to be construed as a limitation, and any number or combination of flow diagram and/or method operations described herein (e.g., of FIGS. 3, 4, and/or 5) may be performed in any order, number, or combination to perform any variation of a flow diagram and/or method described herein.

At 402, the method 400 includes identifying a first earphone of a pair of earphones connected to the electronic device, the pair of earphones including the first earphone and a second earphone. For example, the audio controller 114 detects that the first earphone 120 connects to or is connected to the electronic device 102.

At 404, the method 400 includes converting stereo audio content to mono audio content in response to a detection that the first earphone is used by a first user and that the second earphone is not used by the first user. For example, the audio controller 114 detects that the first earphone 120 is used by the first user, that the first earphone 120 is being used by the first user, that the first earphone 120 is powered on, that the first earphone 120 is activated, and/or that the first earphone 120 is connected to the electronic device 102. Additionally or alternatively, the audio controller 114 detects that the second earphone 122 is not used by the first user, that the second earphone 122 is powered off, that the second earphone 122 is deactivated, and/or that the second earphone 122 is disconnected from the electronic device 102.

At 406, the method 400 includes transmitting the mono audio content to the first earphone. For example, the audio controller 114 converts stereo audio content from the electronic device 102 to mono audio content and provides the mono audio content to the first earphone 120.

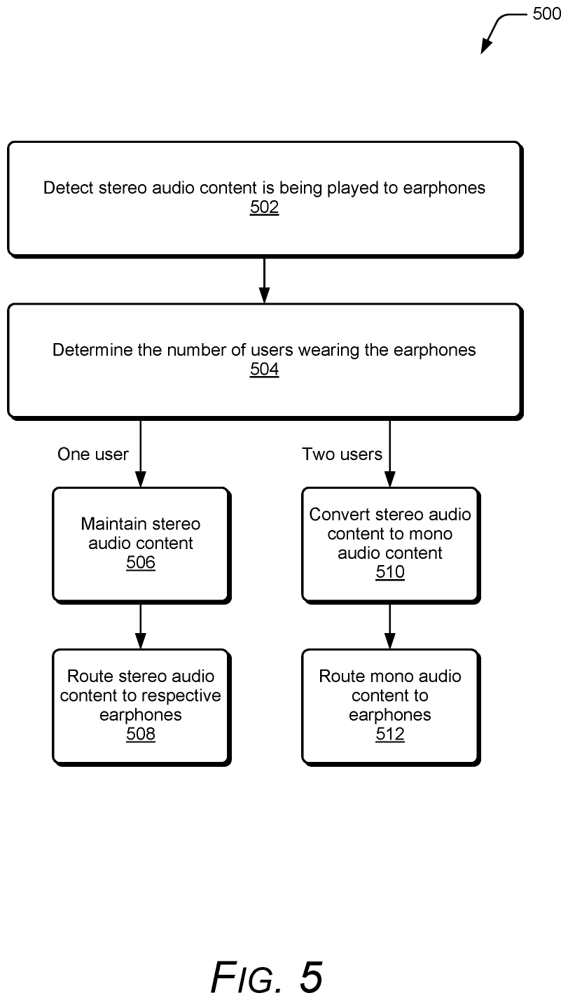

FIG. 5 illustrates example method(s) 500 for converting stereo audio content to mono audio content based on earphone usage. The order in which a flow diagram or method is described is not intended to be construed as a limitation, and any number or combination of flow diagram and/or method operations described herein (e.g., of FIGS. 3, 4, and/or 5) may be performed in any order, number, or combination to perform any variation of a flow diagram and/or method described herein.

At 502, the method 500 includes detecting stereo audio content is being played to earphones. For example, the audio controller 114 detects that audio content is being provided to the first earphone 120 and/or to the second earphone 122 and determines that the audio content being provided to the earphones 104 is stereo audio content (e.g., two or more channels of audio content).

At 504, the method 500 includes determining the number of users wearing the earphones. For example, the audio controller 114 determines whether one user is wearing the first earphone 120 and the second earphone 122 is not being used, or whether the first earphone 120 and the second earphone 122 are being worn by the same person, or whether the first earphone 120 is being used (e.g., worn) by a first user and the second earphone 122 is being used by a second user.

At 506, the method 500 includes maintaining the stereo audio content. For example, the audio controller 114 maintains the stereo audio content (e.g., skips or avoids downmixing the stereo audio content) when the audio controller 114 determines that the first earphone 120 and the second earphone 122 are worn by one user.

At 508, the method 500 includes routing the stereo audio content to respective earphones. For example, based on the stereo audio content being maintained, the audio controller 114 routes a first channel of the stereo audio content to the first earphone 120 and routes a second channel of the stereo audio content to the second earphone 122.

At 510, the method 500 includes converting the stereo audio content to mono audio content. For example, the audio controller 114 converts the stereo audio content to mono audio content when the audio controller 114 determines that the first earphone 120 is being used by a first user and the second earphone 122 is being used by a second user. Additionally or alternatively, the audio controller 114 converts the stereo audio content to mono audio content when the audio controller 114 determines that one user is wearing the first earphone 120 and the second earphone 122 is not being used.

At 512, the method 500 includes routing the mono audio content to one or more earphones. For example, the audio controller 114 routes the mono audio content to the first earphone 120 and routes the mono audio content to the second earphone 122 when the audio controller 114 determines that the first earphone 120 is being used by a first user and the second earphone 122 is being used by a second user. Additionally or alternatively, the audio controller 114 routes the mono audio content to the first earphone 120 and skips routing the mono audio content to the second earphone 122 when the audio controller 114 determines that one user is wearing the first earphone 120 and that the second earphone 122 is not being used.

FIG. 6 illustrates various components of an example device 600, which can implement aspects of the techniques and features for converting stereo audio content to mono audio content based on earphone usage, as described herein. The example device 600 may be implemented as any of the devices described with reference to the previous FIGS. 1-5, such as any type of a wireless device, mobile device, mobile phone, flip phone, client device, companion device, paired device, display device, tablet, computing, communication, entertainment, gaming, media playback, and/or any other type of computing and/or electronic device. For example, the electronic device 102 and/or the earphones 104 described with reference to FIGS. 1-5 may be implemented as the example device 600.

The example device 600 can include various, different communication devices 602 that enable wired and/or wireless communication of device data 604 with other devices. The device data 604 can include any of the various devices data and content that is generated, processed, determined, received, stored, and/or communicated from one computing device to another. Generally, the device data 604 can include any form of audio, video, image, graphics, and/or electronic data that is generated by applications executing on a device. The communication devices 602 can also include transceivers for cellular phone communication and/or for any type of network data communication.

The example device 600 can also include various, different types of data input/output (I/O) interfaces 606, such as data network interfaces that provide connection and/or communication links between the devices, data networks, and other devices. The I/O interfaces 606 may be used to couple the device to any type of components, peripherals, and/or accessory devices, such as a computer input device that may be integrated with the example device 600. The I/O interfaces 606 may also include data input ports via which any type of data, information, media content, communications, messages, and/or inputs may be received, such as user inputs to the device, as well as any type of audio, video, image, graphics, and/or electronic data received from any content and/or data source.

The example device 600 includes a processor system 608 of one or more processors (e.g., any of microprocessors, controllers, and the like) and/or a processor and memory system implemented as a system-on-chip (SoC) that processes computer-executable instructions. The processor system 608 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device may be implemented with any one or combination of software, hardware, firmware, or fixed logic circuitry that may be implemented in connection with processing and control circuits, which are generally identified at 610. The example device 600 may also include any type of a system bus or other data and command transfer system that couples the various components within the device. A system bus can include any one or combination of different bus structures and architectures, as well as control and data lines.

The example device 600 also includes memory and/or memory devices 612 (e.g., computer-readable storage memory) that enable data storage, such as data storage devices implemented in hardware which may be accessed by a computing device, and that provide persistent storage of data and executable instructions (e.g., software applications, programs, functions, and the like). Examples of the memory devices 612 include volatile memory and non-volatile memory, fixed and removable mobile devices, and any suitable memory device or electronic data storage that maintains data for computing device access. The memory devices 612 can include various implementations of random-access memory (RAM), read-only memory (ROM), flash memory, and other types of storage media in various memory device configurations. The example device 600 may also include a mass storage mobile device.

The memory devices 612 (e.g., as computer-readable storage memory) provide data storage mechanisms, such as to store the device data 604, other types of information and/or electronic data, and various device applications 614 (e.g., software applications and/or modules). For example, an operating system 616 may be maintained as software instructions with a memory device 612 and executed by the processor system 608 as a software application. The device applications 614 may also include a device manager, such as any form of a control application, software application, signal-processing and control module, code that is specific to a particular device, a hardware abstraction layer for a particular device, and so on.

In one or more examples, the device 600 includes an audio controller 618 that implements various aspects of the described features and techniques described herein. The audio controller 618 is implemented with hardware components and/or in software as one of the device applications 614, such as when the example device 600 is implemented as the electronic device 102 and/or the earphones 104 described with reference to FIGS. 1-5. An example of the audio controller 618 is the audio controller 114 implemented by the electronic device 102 and/or the earphones 104, such as a software application and/or as hardware components in the electronic device 102 and/or in the earphones 104. In implementations, the audio controller 618 includes independent processing, memory, and logic components as a computing and/or electronic device integrated with the example device 600.

The example device 600 can also include a microphone 620 (e.g., to capture an audio recording of a user) and/or camera devices 622 (e.g., to capture video images of the user during a call), as well as motion sensors 624, such as may be implemented as components of an inertial measurement unit (IMU). The motion sensors 624 may be implemented with various sensors, such as a gyroscope, an accelerometer, and/or other types of motion sensors to sense motion of the device. The motion sensors 624 can generate sensor data vectors having three-dimensional parameters (e.g., rotational vectors in x, y, and z-axis coordinates) indicating location, position, acceleration, rotational speed, and/or orientation of the device. The example device 600 can also include one or more power sources 626, such as when the device is implemented as a wireless device and/or mobile device. The power sources may include a charging and/or power system, and may be implemented as a flexible strip battery, a rechargeable battery, a charged super-capacitor, and/or any other type of active or passive power source.

The example device 600 can also include an audio and/or video processing system 628 that generates audio data for an audio system 630 and/or generates display data for a display system 632. The audio system and/or the display system may include any types of devices or modules that generate, process, display, and/or otherwise render audio, video, display, and/or image data. Display data and audio signals may be communicated to an audio component and/or to a display component via any type of audio and/or video connection or data link. In implementations, the audio system and/or the display system are integrated components of the example device 600. Alternatively, the audio system and/or the display system are external, peripheral components to the example device.

Although implementations for converting stereo audio content to mono audio content based on earphone usage have been described in language specific to features and/or methods, the appended claims are not necessarily limited to the specific features or methods described. Rather, the specific features and methods are disclosed as example implementations for converting stereo audio content to mono audio content based on earphone usage, and other equivalent features and methods are intended to be within the scope of the appended claims. Further, various different examples are described, and it is to be appreciated that each described example may be implemented independently or in connection with one or more other described examples. Additional aspects of the techniques, features, and/or methods discussed herein relate to one or more of the following:

In some aspects, the techniques described herein relate to an electronic device, including: at least one memory; and at least one processor coupled with the at least one memory configured to cause the electronic device to: identify a first earphone of a pair of earphones connected to the electronic device, the pair of earphones including the first earphone and a second earphone; convert stereo audio content to mono audio content in response to a detection that the first earphone is used by a first user and that the second earphone is not used by the first user; and transmit the mono audio content to the first earphone.

In some aspects, the techniques described herein relate to an electronic device, wherein the at least one processor is configured to cause the electronic device to: detect that the second earphone is used by a second user and the first earphone is used by the first user; and transmit the mono audio content to the second earphone.

In some aspects, the techniques described herein relate to an electronic device, wherein the detection that the second earphone is used by the second user and the first earphone is used by the first user is based on the at least one processor causing the electronic device to: analyze a signal from an inertial measurement sensor of the first earphone and a signal from an inertial measurement sensor of the second earphone; and determine, based on the analysis, that the first earphone and the second earphone are worn by different users.

In some aspects, the techniques described herein relate to an electronic device, wherein the at least one processor is configured to cause the electronic device to: detect that the first earphone and the second earphone are used by the first user; stop the conversion of the stereo audio content to the mono audio content; and transmit a first channel of the stereo audio content to the first earphone and a second channel of the stereo audio content to the second earphone.

In some aspects, the techniques described herein relate to an electronic device, wherein the detection that the first earphone is used by the first user is based on the at least one processor causing the electronic device to: receive a proximity indication from a proximity sensor of the first earphone; and determine the first earphone is used by the first user based on the proximity indication.

In some aspects, the techniques described herein relate to an electronic device, wherein the conversion of the stereo audio content to the mono audio content is based on the at least one processor being configured to cause the electronic device to: detect content of a first channel of the stereo audio content that is absent on a second channel of the stereo audio content; and add the content of the first channel to the second channel.

In some aspects, the techniques described herein relate to an electronic device, wherein the at least one processor is configured to cause the electronic device to: detect destructive interference based on a first channel of the stereo audio content being combined with a second channel of the stereo audio content; and before conversion of the stereo audio content to the mono audio content, perform signal processing on at least one of the first channel or the second channel to remove the destructive interference.

In some aspects, the techniques described herein relate to an electronic device, wherein the pair of earphones include at least one of an in-ear wireless headphone, a wireless earbud, or a true wireless earbud.

In some aspects, the techniques described herein relate to a method, including: identifying a first earphone of a pair of earphones connected to an electronic device, the pair of earphones including the first earphone and a second earphone; converting stereo audio content to mono audio content in response to a detection that the first earphone is used by a first user and that the second earphone is not used by the first user; and transmitting the mono audio content to the first earphone.

In some aspects, the techniques described herein relate to a method, further including: detecting that the second earphone is used by a second user and the first earphone is used by the first user; and transmitting the mono audio content to the second earphone.

In some aspects, the techniques described herein relate to a method, wherein the detection that the second earphone is used by the second user and the first earphone is used by the first user is based on: analyzing a signal from an inertial measurement sensor of the first earphone and a signal from an inertial measurement sensor of the second earphone; and determining, based on the analysis, that the first earphone and the second earphone are worn by different users.

In some aspects, the techniques described herein relate to a method, further including: detecting that the first earphone and the second earphone are used by the first user; stop the conversion of the stereo audio content to the mono audio content; and transmitting a first channel of the stereo audio content to the first earphone and a second channel of the stereo audio content to the second earphone.

In some aspects, the techniques described herein relate to a method, wherein the detection that the first earphone is used by the first user is based on: receiving a proximity indication from a proximity sensor of the first earphone; and determining the first earphone is used by the first user based on the proximity indication.

In some aspects, the techniques described herein relate to a method, wherein the conversion of the stereo audio content to the mono audio content is based on: detecting content of a first channel of the stereo audio content that is absent on a second channel of the stereo audio content; and adding the content of the first channel to the second channel.

In some aspects, the techniques described herein relate to a method, further including: detecting destructive interference based on a first channel of the stereo audio content being combined with a second channel of the stereo audio content; and before conversion of the stereo audio content to the mono audio content, performing signal processing on at least one of the first channel or the second channel to remove the destructive interference.

In some aspects, the techniques described herein relate to a method, wherein the pair of earphones include at least one of an in-ear wireless headphone, a wireless earbud, or a true wireless earbud.

In some aspects, the techniques described herein relate to a system, including: a communication interface to wirelessly link an electronic device to earphones that include a first earphone and a second earphone; and an audio controller configured to convert stereo audio content to mono audio content, the audio controller implemented at least partially in computer hardware to: identify the first earphone connected to the electronic device; convert stereo audio content to mono audio content in response to a detection that the first earphone is used by a first user and that the second earphone is not used by the first user; and transmit the mono audio content to the first earphone.

In some aspects, the techniques described herein relate to a system, wherein the audio controller causes the computer hardware to: detect that the second earphone is used by a second user and the first earphone is used by the first user; and transmit the mono audio content to the second earphone.

In some aspects, the techniques described herein relate to a system, wherein the detection that the second earphone is used by the second user and the first earphone is used by the first user is based on the audio controller causing the computer hardware to: analyze a signal from an inertial measurement sensor of the first earphone and a signal from an inertial measurement sensor of the second earphone; and determine, based on the analysis, that the first earphone and the second earphone are worn by different users.

In some aspects, the techniques described herein relate to a system, wherein the audio controller causes the computer hardware to: detect that the first earphone and the second earphone are used by the first user; stop the conversion of the stereo audio content to the mono audio content; and transmit a first channel of the stereo audio content to the first earphone and a second channel of the stereo audio content to the second earphone.

1. An electronic device, comprising:
at least one memory; and
at least one processor coupled with the at least one memory configured to cause the electronic device to:
identify a first earphone of a pair of earphones connected to the electronic device, the pair of earphones including the first earphone and a second earphone;
convert stereo audio content to mono audio content in response to a detection that the first earphone is used by a first user and that the second earphone is not used by the first user; and
transmit the mono audio content to the first earphone.

2. The electronic device of claim 1, wherein the at least one processor is configured to cause the electronic device to:
detect that the second earphone is used by a second user and the first earphone is used by the first user; and
transmit the mono audio content to the second earphone.

3. The electronic device of claim 2, wherein the detection that the second earphone is used by the second user and the first earphone is used by the first user is based on the at least one processor causing the electronic device to:
analyze a signal from an inertial measurement sensor of the first earphone and a signal from an inertial measurement sensor of the second earphone; and
determine, based on the analysis, that the first earphone and the second earphone are worn by different users.

4. The electronic device of claim 1, wherein the at least one processor is configured to cause the electronic device to:
detect that the first earphone and the second earphone are used by the first user;
stop the conversion of the stereo audio content to the mono audio content; and
transmit a first channel of the stereo audio content to the first earphone and a second channel of the stereo audio content to the second earphone.

5. The electronic device of claim 1, wherein the detection that the first earphone is used by the first user is based on the at least one processor causing the electronic device to:
receive a proximity indication from a proximity sensor of the first earphone; and
determine the first earphone is used by the first user based on the proximity indication.

6. The electronic device of claim 1, wherein the conversion of the stereo audio content to the mono audio content is based on the at least one processor being configured to cause the electronic device to:
detect content of a first channel of the stereo audio content that is absent on a second channel of the stereo audio content; and
add the content of the first channel to the second channel.

7. The electronic device of claim 1, wherein the at least one processor is configured to cause the electronic device to:
detect destructive interference based on a first channel of the stereo audio content being combined with a second channel of the stereo audio content; and
before conversion of the stereo audio content to the mono audio content, perform signal processing on at least one of the first channel or the second channel to remove the destructive interference.

8. The electronic device of claim 1, wherein the pair of earphones include at least one of an in-ear wireless headphone, a wireless earbud, or a true wireless earbud.

9. A method, comprising:
identifying a first earphone of a pair of earphones connected to an electronic device, the pair of earphones including the first earphone and a second earphone;
converting stereo audio content to mono audio content in response to a detection that the first earphone is used by a first user and that the second earphone is not used by the first user; and
transmitting the mono audio content to the first earphone.

10. The method of claim 9, further comprising:
detecting that the second earphone is used by a second user and the first earphone is used by the first user; and
transmitting the mono audio content to the second earphone.

11. The method of claim 10, wherein the detection that the second earphone is used by the second user and the first earphone is used by the first user is based on:
analyzing a signal from an inertial measurement sensor of the first earphone and a signal from an inertial measurement sensor of the second earphone; and
determining, based on the analysis, that the first earphone and the second earphone are worn by different users.

12. The method of claim 9, further comprising:
detecting that the first earphone and the second earphone are used by the first user;
stop the conversion of the stereo audio content to the mono audio content; and
transmitting a first channel of the stereo audio content to the first earphone and a second channel of the stereo audio content to the second earphone.

13. The method of claim 9, wherein the detection that the first earphone is used by the first user is based on:
receiving a proximity indication from a proximity sensor of the first earphone; and
determining the first earphone is used by the first user based on the proximity indication.

14. The method of claim 9, wherein the conversion of the stereo audio content to the mono audio content is based on:
detecting content of a first channel of the stereo audio content that is absent on a second channel of the stereo audio content; and
adding the content of the first channel to the second channel.

15. The method of claim 9, further comprising:
detecting destructive interference based on a first channel of the stereo audio content being combined with a second channel of the stereo audio content; and
before conversion of the stereo audio content to the mono audio content, performing signal processing on at least one of the first channel or the second channel to remove the destructive interference.

16. The method of claim 9, wherein the pair of earphones include at least one of an in-ear wireless headphone, a wireless earbud, or a true wireless earbud.

17. A system, comprising:
a communication interface to wirelessly link an electronic device to earphones that include a first earphone and a second earphone; and
an audio controller configured to convert stereo audio content to mono audio content, the audio controller implemented at least partially in computer hardware to:
identify the first earphone connected to the electronic device;
convert stereo audio content to mono audio content in response to a detection that the first earphone is used by a first user and that the second earphone is not used by the first user; and
transmit the mono audio content to the first earphone.

18. The system of claim 17, wherein the audio controller causes the computer hardware to:
detect that the second earphone is used by a second user and the first earphone is used by the first user; and
transmit the mono audio content to the second earphone.

19. The system of claim 18, wherein the detection that the second earphone is used by the second user and the first earphone is used by the first user is based on the audio controller causing the computer hardware to:
analyze a signal from an inertial measurement sensor of the first earphone and a signal from an inertial measurement sensor of the second earphone; and
determine, based on the analysis, that the first earphone and the second earphone are worn by different users.

20. The system of claim 17, wherein the audio controller causes the computer hardware to:
detect that the first earphone and the second earphone are used by the first user;
stop the conversion of the stereo audio content to the mono audio content; and
transmit a first channel of the stereo audio content to the first earphone and a second channel of the stereo audio content to the second earphone.
